(19) United States
(12) Patent Application Publication
(10) Pub. No.: US 2021/0141892 A1
(43) Pub. Date: May 13, 2021

(54) SYSTEM AND METHOD FOR USER AUTHENTICATION

(71) Applicant: IQ2 HOLDINGS, INC., Montreal (CA)

(72) Inventor: Mathieu Chambon-Cartier, Montreal (CA)

(73) Assignee: IQ2 HOLDINGS, INC., Montreal (CA)

(21) Appl. No.: 17/009,394

(22) Filed: Sep. 1, 2020

Related U.S. Application Data
(60) Provisional application No. 62/933,652, filed on Nov. 11, 2019.

(51) Int. Cl. G06F 21/46; H04N 21/258; H04N 21/475; G06F 21/36; G06Q 20/40; G06Q 20/10

(52) U.S. Cl. CPC G06F 21/46; H04N 21/25875; G06Q 20/102; G06F 21/36; G06Q 20/4014; H04N 21/4753

(57) ABSTRACT

A system may provide a process to authenticate a user prior to allowing access to proprietary media content on a content platform, based on a visual or vocal selection of a predefined group of virtual interactive objects in a predetermined sequence from media content, which is currently being presented on an electronic device of the user. The predefined group of virtual interactive objects may form a preselected password of the user for gaining access to the proprietary media content on the content platform.

This application claims the benefit of and priority to U.S. Provisional Application No. 62/933,652, filed Nov. 11, 2019, and all the benefits accruing therefrom under 35 U.S.C. § 119 and § 120, the contents of which are incorporated herein by reference in their entirety.

The present application relates generally to authentication methods and systems.

### BACKGROUND

A content provider may generate video media (e.g., a movie, a television show, or a documentary). The video media may include multiple scenes, such as those presenting actors, scenery, and objects. Various content platforms, such as broadcast television programs, cable television programs, satellite television programs, and internet-based programs may stream the video media. A user may view the video media via one of these content platforms on an electronic device, such as a mobile phone, a television, or a computer.

The user may have an account associated with a content platform. The user may submit authentication inputs, such as a password to access the account and then view the video media via the content platform on a display screen of the electronic device. Typically, the user may have to go through an authentication process each time the user may want to view a new video media on the content platform.

The user may use a text-based password, which may be fraught with typing errors and case-sensitive requirements. Furthermore, for some services that require added security, like this account at the content platform, the use of the text-based password as a means of identification and authentication is not strong enough. It is therefore recommended by cyber security professionals that the text-based password be changed frequently. Accordingly, the user may have to seldom change the text-based password and the user may find it extremely difficult to remember constantly changing passwords.

Another problem with knowledge-based authentication process based on the text-based password is that the user is not able to perform simultaneous actions while accessing the content platform. For instance, if the user is watching a first video media on the content platform and the user is interested in watching a second video media after the first video media, the user may have to wait until the first video media is over. The user may then close the first video media on the content platform. The user may then access an authentication page and submit the text-based password. The user may get re-authenticated. The user may then play the second video media on the content platform. Accordingly, this is a multi-step authentication process where each step has to be performed one after the other.

In some cases, during the authentication process, the user may not have to close the first video media on the content platform when making a request for viewing the second video media. In such cases, upon making the request, an authentication prompt may be presented on the display screen while the user is watching the first video media. The authentication prompt may affect the display of the first video media, which may create bad user experience.

### SUMMARY

For the aforementioned reasons, what is therefore needed is a technique to simplify a process for end-user authentication on a content platform without a need for an additional authentication prompt on a display screen of an electronic device of a user. The technique may include a process to authenticate the user requesting access to new media content on the content platform, based on a selection of a predefined group of virtual interactive objects in a predetermined sequence from media content, which is currently being presented on the electronic device. Systems and methods described herein aim to seamlessly overlay the predefined group of virtual interactive objects in the media content being presented on the electronic device to appear as content. The systems and methods may edit the media content being presented on the electronic device to include the predefined group of virtual interactive objects. The predefined group of virtual interactive objects may be selected based on information associated with a preselected password of the user.

In one embodiment, a method may include displaying, by a server, a first digital content file on a graphical user interface of an electronic device, wherein the first digital content file comprises a plurality of virtual interactive objects; receiving, by the server, a request from the electronic device while the first digital content file is being displayed on the graphical user interface for presenting a second digital content file on the graphical user interface; initiating, by the server, an authentication process for authenticating information associated with a user prior to presenting the second digital content file on the graphical user interface; selecting, by the server, a predefined number of virtual interactive objects in a predetermined sequence from the first digital content file being displayed on the graphical user interface based on recognizing a voice uttered by the user or tracking an eye movement of the user relative to the graphical user interface during the authentication process; when the predefined number of virtual interactive objects selected in the predetermined sequence form a preselected password of the user, authenticating, by the server, the user; and displaying, by the server, the second digital content file on the graphical user interface of the electronic device.

In another embodiment, a system may include a server configured to retrieve a first digital content file displaying a plurality of virtual interactive objects from a digital content source, in response to receiving a first request from an electronic device operated by a user; present the first digital content file on a graphical user interface of the electronic device; receive a second request from the electronic device while the first digital content file is being played on the electronic device for presenting a second digital content file on the electronic device, wherein the digital content source comprises the second digital content file; in response to receiving the second request, initiate an authentication process while the first digital content file is being played on the electronic device for authenticating information associated with the user prior to presenting the second digital content file on the electronic device; select a predefined number of virtual interactive objects in a predetermined sequence from the first digital content file being played on the electronic device based on recognizing a voice uttered by the user or tracking an eye movement of the user relative to the graphical user interface during the authentication process; when the predefined number of virtual interactive objects selected in the predetermined sequence form a preselected password of the user, authenticate the user as the given user of the preselected password; and present the second digital content file on the graphical user interface of the electronic device.

It is to be understood that both the foregoing general description and the following detailed description are exemplary and explanatory and are intended to provide further explanation of the subject matter as claimed.

### BRIEF DESCRIPTION OF THE DRAWINGS

Non-limiting embodiments of present disclosure are described by way of example with reference to accompanying figures, which are schematic and are not intended to be drawn to scale. Unless indicated as representing background art, the figures represent aspects of the present disclosure.

FIG. 1 shows various components of a system, according to an embodiment.

FIG. 2 shows a visual selection technique being executed by a user to select one or more virtual objects in an immersive environment during an authentication process, according to an embodiment.

FIG. 3 shows a voice recognition technique being executed by a user to select one or more virtual objects in an immersive environment during an authentication process, according to an embodiment.

FIG. 4 shows selection of one or more virtual objects in an immersive environment using a visual selection technique during an authentication process of a user, according to an embodiment.

FIG. 5 shows selection of one or more virtual objects in an immersive environment using a voice recognition technique during an authentication process of a user, according to an embodiment.

FIG. 6 shows a method for user authentication, according to an embodiment.

### DETAILED DESCRIPTION

Reference will now be made to the embodiments in the drawings, and specific language will be used here to describe the same. It will nevertheless be understood that no limitation of the scope of the claims or this disclosure is thereby intended. Alterations and further modifications of the features explained herein, and additional applications of the principles of the subject matter explained herein, which would occur to one skilled in the relevant art and having possession of this disclosure, are to be considered within the scope of the subject matter disclosed herein. The present disclosure is here described in detail with reference to embodiments explained in the drawings, which form a part here. Other embodiments may be used and/or other changes may be made without departing from the spirit or scope of the present disclosure. The embodiments described in the detailed description are not meant to be limiting of the subject matter presented here.

FIG. 1 shows various components of a system 100. The system 100 may include one or more system servers 102, one or more record servers 104, one or more electronic devices 106, a database subsystem 108, and an electronic file generator 110. The database subsystem 108 may include a database 112 and one or more database servers 114. The electronic file generator 110 may include microphones 116, a processor 118, a storage 120, and cameras 122.

The system 100 may operate in a local computing environment where different devices of the system 100 may execute various tasks, such as authentication tasks in a local environment. When the system 100 may operate in the local computing environment, the one or more system servers 102 may be installed on premises, and may provide users of the one or more electronic devices 106 local access to stored data and applications. In another embodiment, the system 100 may operate in a cloud-computing environment where different devices of the system 100 may be cloud-optimized. When the system 100 may operate in the cloud-computing environment, the one or more system servers 102 and other software's may be hosted in the cloud, which may enable a real-time virtual environment hosted between the one or more system servers 102 and the one or more electronic devices 106 at the same time.

The system 100 is described in a context of computer-executable instructions, such as program modules, being executed by server computers, such as at least one system server 102. The system server 102 may operate various software programs and applications, such as a media streaming application, an image personalization application, and an authentication application. The media streaming application may include programs, objects, components, data structures, etc., which may be directly or indirectly, associated with programs, objects, components, and data structures of the image personalization application and the authentication application. The electronic devices 106 may install and execute the media streaming application to perform various tasks and sub-tasks. The features of the system 100 may be practiced either in a single computing device, or in a distributed computing environment, where various tasks and sub-tasks may be performed by processing devices, which are linked through a network 124. In the distributed computing environment, the various program modules may be located in both local and remote computer storage media including memory storage devices.

The one or more system servers 102, the one or more record servers 104, the one or more electronic devices 106, the database subsystem 108, and the electronic file generator 110 may communicate with each other over the network 124. The network 124 may include, but is not limited to, a private local area network, a public local area network, a wireless local area network, a metropolitan area network, a wide-area network, and Internet. The network 124 may further include both wired and wireless communications, according to one or more standards, via one or more transport mediums. The communication over the network 124 is in accordance with various communication protocols, such as a transmission control protocol and an internet protocol, a user datagram protocol, and an institute of electrical and electronics engineers communication protocols. The network 124 may further include wireless communications, according to Bluetooth specification sets, or another standard or proprietary wireless communication protocol. The network 124 may further include communications over a cellular network, including, for example, a global system for mobile communications, code division multiple access, and enhanced data for global evolution network. The network 124 may further include hardware devices (e.g., routers, switches, firewalls) and software components configured to relay data communications between different computing devices and applications associated with the system 100.

An electronic file generator 110 is a portable or a non-portable electronic device, which may be configured to generate one or more electronic files, such as digital content files containing audio data and video data. The electronic file generator 110 may perform one or more operations according to one or more programming instructions. The one or more operations may include execution of one or more algorithms or computer executable program instructions. The one or more algorithms may include the image personalization application. A single processor 118 or multiple processors of the electronic file generator 110 in a distributed configuration may execute the one or more algorithms or computer executable program instructions. The electronic file generator 110 may interact with one or more software modules of a same or a different type operating within the system 100.

The electronic file generator 110 may include the processor 118 for performing computations for carrying the functions of the electronic file generator 110. Non-limiting examples of the processor 118 may include, but not limited to, an application specific integrated circuit, a field programmable object array, among others. The processor 118 may include a graphics processing unit specialized for rendering and generating computer-generated graphics. Non-limiting examples of the electronic file generator 110 may include, but are not limited to, a camera 122 or a computer.

The electronic file generator 110 may include an operating system for managing various resources of the electronic file generator 110. An application-programming interface associated with the operating system may allow various application programs, such as media streaming application programs to access various services offered by the operating system. For example, the application-programming interface may set up wired or wireless connections to the one or more electronic devices 106, the one or more system servers 102, and the one or more record servers 104. As a result, the electronic file generator 110 may be capable of communicating with the one or more electronic devices 106, the one or more system servers 102, and the one or more record servers 104 through the network 124 using wired or wireless communication capabilities.

The electronic file generator 110 may include the processor 118, which may execute filming techniques to generate the one or more digital content files. The filming techniques may include three-dimensional filming techniques and four-dimensional filming techniques. The filming techniques may include various software's, such as a development software, a pre-production software, a production software, and a post-production software. Using the filming techniques, the camera 122 of the electronic file generator 110 may generate the one or more digital content files. The cameras 122 may receive an input from an environment that is within a field of view of the electronic file generator 110. The input may include, for example, light images, such as video images and still images. The electronic file generator 110 may obtain and process the input in real-time.

The electronic file generator 110 may execute the filming techniques to analyze the received input and generate data, such as three-dimensional data and four-dimensional data of the environment. The data of the environment may include information associated with data points in the three-dimensional and/or the four-dimensional space of the field of view, for example, in a Cartesian coordinate system or a polar coordinate system. The data may include color and other information associated with the positions of the data points in the field of view. The electronic file generator 110 may process the data and generate at least one digital content file, which may be an output file. The digital content file may include one or more images. The one or more images may include a plurality of virtual interactive objects. The plurality of virtual interactive objects may include items, letters, humans, texts, characters, symbols, pictures, etc. The electronic file generator 110 may further include an optical projection module that can project the digital content file generated by the processor 118 onto a display associated with the electronic file generator 110 or into the environment to establish an augmented reality or a virtual reality.

The electronic file generator 110 may receive information associated with preselected password of the user from other devices of the system 100, such as the one or more system servers 102 and the one or more electronic devices 106. The preselected password of the user may be a password for an online banking account of the user. The preselected password of the user may be a password for an account of the user on a media streaming application. The information associated with the preselected password may include a combination of one or more virtual interactive objects. The electronic file generator 110 may identify the one or more virtual interactive objects in the plurality of virtual interactive objects of the digital content file during the creation of the digital content file. The electronic file generator 110 may execute the filming techniques and the image personalization application to mark or tag the one or more virtual interactive objects of the plurality of virtual interactive objects. These one or more marked and tagged virtual interactive objects may form an arbitrary string of characters associated with the preselected password. When the one or more virtual interactive objects may not be present in the plurality of virtual interactive objects of the digital content file, the electronic file generator 110 may execute the filming techniques and the image personalization application to update the digital content file, and include the one or more virtual interactive objects in the digital content file. An updated digital content file may include the one or more marked and tagged virtual interactive objects, which may form the preselected password.

The electronic file generator 110 may execute the filming techniques and the image personalization application to mark or tag the one or more virtual interactive objects after the creation of the digital content file, and then re-create the digital content file. The electronic file generator 110 may mark or tag the one or more virtual interactive objects in the digital content file using tags, such as machine-readable codes. The machine-readable codes may be placed on a body of the one or more virtual interactive objects in the digital content file. The machine-readable codes may be visible on the body of the one or more virtual interactive objects. The machine-readable codes may not be clearly visible on the body of the one or more virtual interactive objects. The machine-readable codes may include bar codes and quick response codes.

The electronic file generator 110 may store the digital content file, which may include the one or more marked and tagged virtual interactive objects in the storage 120. The one or more marked and tagged virtual interactive objects may be randomly arranged in overall content of the digital content file. The digital content file may further include multiple virtual interactive objects, which may be untagged.

The electronic file generator 110 may receive a request from the at least one electronic device 106 via the at least one system server 102. The request may be to access at least one digital content file on the electronic device 106. In some instances, the electronic file generator 110 may receive the request via the media streaming application running on the electronic device 106 to access the at least one digital content file. In one embodiment, the electronic device 106 may generate a first request when no digital content file is currently being played on the electronic device 106. The electronic file generator 110 on receiving the first request may electronically transmit a first digital content file associated with the first request to the electronic device 106 via the system server 102. The electronic device 106 may receive the first digital content file via the media streaming application. The user may view and play the first digital content file via the media streaming application on the electronic device 106. In another embodiment, the electronic device 106 may generate a second request when some digital content file is currently being played on the electronic device 106. The electronic file generator 110 on receiving the second request may confirm authentication of the user, and then electronically transmit a second digital content file associated with the second request to the electronic device 106 via the system server 102. The electronic device 106 may receive the second digital content file via the media streaming application. The user may view and play the second digital content file via the media streaming application on the electronic device 106.

An electronic device 106 is a computing device including a processing unit. The processing unit may include a processor with a computer-readable medium, such as a random access memory coupled to the processor. The electronic device 106 may be running algorithms or computer executable program instructions, which may be executed by a single processor or multiple processors in a distributed configuration. The electronic device 106 may interact with one or more software modules of a same or a different type operating within the system 100.

Non-limiting examples of the processor may include, but not limited to, a microprocessor, an application specific integrated circuit, a field programmable object array, among others. The processor may include a graphics processing unit specialized for rendering and generating computer-generated graphics. Non-limiting examples of the electronic device 106 may include, but are not limited to, a cellular phone, a tablet computer, a head-mounted display, smart glasses, wearable computer glasses, a personal data assistant, a virtual reality device, an augmented reality device, or a personal computer.

The electronic device 106 may include a transmitter and a receiver. The transmitter may transmit or broadcast signals to the receiver. The signals may be voice signals of the user. The signals may be eye movement and retinal signals of the user. The signals may be body heat signals of the user. The signals may be heart rate signals of the user. The transmitter and the receiver may be permanently integrated into the electronic device 106, which may result in a single integrated product or unit. The transmitter and the receiver may be detachably coupled to the electronic device 106. For instance, the electronic device 106 may be placed into a protective sleeve containing embedded transmitter and receiver that are detachably coupled to the electronic device 106 power supply input. The electronic device 106 may further include embedded or associated cameras and sensors, which may act as a data source for the transmitter to supplement data and signals, as generated by the electronic device 106 physically associated with the transmitter.

The electronic device 106 may include an antenna array, which may be a set of one or more antennas configured to transmit and receive data and signals from the transmitter and the receiver. The antenna array may include antenna elements, which may be configurable tiles including an antenna and integrated circuits controlling the behavior of the antenna in that element, such as having predetermined characteristics (e.g., amplitude, frequency, trajectory, phase). The antenna of the antenna array may transmit a series of signals having predetermined characteristics, such that the series of signals arrive at a given location within a communication field of the electronic device 106 and exhibit those characteristics.

The electronic device 106 may include the camera. The camera may generate multiple digital content files containing a stream of images, which may be stored in a local memory. The images may include multiple virtual interactive objects. In some instances, the electronic file generator 110 may transmit one or more digital content files to the electronic device 106 on receiving the request from the electronic device 106. The multiple digital content files may be accessed and played on the electronic device 106 via the media streaming application. A display screen of the electronic device 106 may display the digital content files via a graphical user interface of the media streaming application. The display screen may be a light emitting display for presentation of media content of the digital content files in an interactive and a visual form. The display screen may include a head-mounted display system for optically presenting the media content of the digital content files into the eyes of the user through a virtual retinal display.

The electronic device 106 may include the sensor. The sensor may be physically associated with the electronic device 106 (i.e., connected to, or a component of). The sensor may detect a presence of the user in proximity to the electronic device 106. In some instance, the sensor may detect the presence of the user in proximity to the electronic device 106 only when any digital content file is accessed and played on the electronic device 106. The sensor may determine if any user is in proximity to the electronic device 106 when any digital content file is being accessed and played on the electronic device 106. The sensor may further determine a location of the user with respect to the electronic device 106 when any digital content file is being accessed and played on the electronic device 106. The sensor may further recognize and record voice of the user when any digital content file is being accessed and played on the electronic device 106. The sensor may further detect eye movement of the user with respect to the graphical user interface of the electronic device 106 when any digital content file is being accessed and played on the electronic device 106.

The sensor may generate sensor data associated with the user when any digital content file (for example, a first digital content file) is being accessed and played on the electronic device 106 by the user. Non-limiting examples of the sensor data may include voice data of the user, body temperature data of the user, heart rate data of the user, and eye movement data of the user. The heart rate data of the user may include a number of heart beats of the user in a predetermined amount of time. The body temperature data of the user may include current body temperature of the user. The voice data of the user may include a recording of a voice of the user mentioning about a list of a predefined number of virtual interactive objects in the first digital content file. The eye movement data of the user may include the list of the predefined number of virtual interactive objects in the first digital content file, which may have had prolonged fixations (dwell times) from the eyes of the user while the eyes of the user was moving over different virtual interactive objects in the first digital content file. The sensor may store the sensor data in a local memory of the electronic device 106.

The electronic device 106 may transmit the sensor data to the system server 102 for subsequent processing by the system server 102. The system server 102 may process the sensor data to analyze the interaction between the user and various virtual interactive objects in the first digital content file. Based on the analysis, the system server 102 may determine various modes of operations. These operations may include selecting a new digital content file (for example, a second digital content file) that the user may want to access, authenticating the user for purchase of the second digital content file, playing the second digital content file on the media streaming application being executed on the electronic device 106, and pausing the second digital content file on the media streaming application being executed on the electronic device 106. Additionally or alternatively, a sensor processor may be connected to or housed within the sensor. The sensor processor may include a microprocessor that executes various primary data processing routines, whereby the sensor data received at the system sever 102 has been partially or completely pre-processed as useable data. In such instances, the system server 102 may directly use the sensor data to determine various modes of operations.

The sensor associated with the electronic device 106 may be a passive sensor, an active sensor, or a smart sensor. The different types of sensors may be categorized by sensor type, characteristic hardware, software requirements, and capabilities for eye movement detection and voice recognition of the user. The passive sensor may provide minimal but efficient eye movement and voice discrimination. The passive sensor may be used as a secondary sensor that may be dispersed into a communication field of the electronic device 106, and may be part of the receiver of the electronic device 106 or otherwise independently capture the sensor data associated with the user that may be wirelessly communicated to the sensor processor. The active sensor may provide an efficient and effective eye movement and voice discrimination, and may have minimal processing associated with the sensor data produced. The smart sensor may have an on-board digital signal processing for primary sensor data (e.g., prior to processing by a processor of the electronic device 106 or the system server 102. The smart sensor may be capable of fine, granular eye movement and voice discrimination, and provide the processor of the electronic device 106 or the system server 102 with pre-processed sensor data, which may be more efficiently handled by the processor of the electronic device 106 or the system server 102.

The sensor associated with the electronic device 106 may be configured for a particular user (for example, a first user) eye movement detection and voice recognition, and accordingly may discriminate the first user from other users using the electronic device 106, such as a second user and a third user. The sensor may recognize the first user based on body temperature data associated with the first user, infrared range finder data associated with the first user, motion data associated with the first user, gesture data associated with the first user, and heart rate data associated with the first user. During operation, the sensor may measure the body temperature data associated with the first user, the infrared range-finder data associated with the first user, the motion data associated with the first user, the gesture data associated with the first user, and the heart rate data associated with the first user. The sensor may compare measured data with data associated with the user. Based on a positive result of the comparison, the sensor may confirm an identity of the first user. The sensor may then record and process eye movement data and voice data of the first user.

The electronic device 106 may include an operating system for managing various resources of the electronic device 106. An application-programming interface associated with the operating system may allow various application programs, such as media streaming application programs to access various services offered by the system 100. For example, the application-programming interface may set up wired or wireless connections to the electronic file generator 110, the system servers 102, and the record servers 104. As a result, the electronic device 106 may be capable of communicating with the electronic file generator 110, the system servers 102, and the record servers 104 through the network 124 using wired or wireless communication capabilities.

The electronic device 106 may include a user-side media streaming application. The media streaming application may correspond to a digital content source. The digital content source may be an internet video streaming source, such as Netflix. The user may interact with the media streaming application to receive the digital content files from the electronic file generator 110 and then play the digital content files on the electronic device 106. The media streaming application may be a software stack running on the operating system of the electronic device 106. The media streaming application may have a protocol layer and a user interface layer where each layer may be responsible for specific tasks and functions. The protocol layer may communicate with the operating system, and manages various connections of the electronic device 106 over the network 124. The protocol layer may communicate with the user interface layer. The protocol layer may control the user interface layer to present the digital content files to the user via an application interface of the media streaming application, and to receive information from the user via the application interface.

The electronic device 106 may include a web browser. The electronic device 106 may execute the web browser to access and present a media streaming web application. The electronic device 106 may execute the media streaming web application to access the digital content files from the database 112. The user may view and play the digital content files via a web interface of the media streaming web application. The electronic device 106 may execute the media streaming web application outside of the web browser, for example, an operating system-specific media streaming application that accesses and presents the digital content files via the web interface.

In order to access the media streaming application on the electronic device 106, the electronic device 106 may transmit media streaming application credentials of the user via user inputs to the system server 102, from which the system server 102 may validate the user. The electronic device 106 may include a number of input devices (e.g., a touchscreen) to receive the user inputs, including various types of credentials and data inputs allowing for validation, e.g., username, passwords, certificates, biometrics. When the system server 102 validates the user, the user may have access to features of the media streaming application. The user may use the electronic device 106 to generate and transmit a request to the system server 102 via the media streaming application to access and view the digital content files. In one embodiment, the user may use the electronic device 106 to generate and transmit the first request to the system server 102 when no digital content file is currently being played on the electronic device 106 and the user wants to access the first digital content file. In another embodiment, the user may use the electronic device 106 to generate and transmit the second request to the system server 102 when the first digital content file is being currently played on the electronic device 106 and the user wants to access the second digital content file after viewing the first digital content file. As a result, the user may be able to generate the second request while watching the first digital content file on the electronic device 106. The system server 102 may initiate an authentication process on receiving the second request.

The electronic device 106 may include input and output devices, such as microphone and touch screen display. The input and output devices may allow the user interaction with various programs and computer software applications, such as the media streaming application configured to communicate with the system server 102 in order to view the digital content files on the electronic device 106.

The electronic device 106 may include an interactive graphical user interface on which the user may interact with the media streaming application using its eye movement and voice. The graphical user interface may present notifications to the user, which may be received from the system server 102. The media streaming application may display interactive icons or buttons on the graphical user interface. The triggering of the icons based on the eye movement and the voice of the user may generate a screen having a plurality of portions on the graphical user interface. A first portion of the screen may present a description associated with the notifications. The description of the notifications may include information associated with an account of the user, a description of one or more media content files for purchase etc. The user, via the electronic device 106, may transmit a message reply from a second portion of the screen to the system server 102 in response to the notifications. The second portion of the screen may provide a brief text box (for example, a text box with a pre-defined number of characters) having an expandable text capture capability to capture user's explanation of the message reply to the notifications. The user may create the message reply by interacting with the electronic device 106 using the eye movement and voice of the user. The message reply may include an answer regarding a purchase of a particular media content file.

A system server 102 may be a computing device including a processing unit. The processing unit may include a processor with computer-readable medium, such as a random access memory coupled to the processor. The system server 102 may be running algorithms or computer executable program instructions. A single processor or multiple processors in a distributed configuration of the system server 102 may execute the algorithms or the computer executable program instructions. The system server 102 may interact with one or more software modules of a same or a different type operating within the system 100.

Non-limiting examples of the processor may include a microprocessor, an application specific integrated circuit, and a field programmable object array, among others. Non-limiting examples of the system server 102 may include a server computer, a workstation computer, a tablet device, and a mobile device (e.g., smartphone). For ease of explanation, the FIG. 1 shows multiple computing devices functioning as the system server 102. However, some embodiments may include a single computing device capable of performing tasks described herein.

The system server 102 may operate as a web server hosting the user-centric media streaming application accessible to the electronic device 106 via the network 124. The system server 102 may execute software applications configured to host the media streaming application website (e.g., Apache®, Microsoft IIS®), which may generate and serve various webpages to the electronic device 106. The media streaming application website may be used to access the digital content files stored in the database 112. The electronic file generator 110 may generate the digital content files and store the digital content files in the database 112.

The system server 102 may be associated with the one or more electronic devices 106, the electronic file generator 110, the one or more record servers 104, and the database subsystem 108 via the network 124. The system server 102 may receive the request. For instance, the system server 102 may receive the request (for example, the first request) directly from the electronic device 106 when the user of the electronic device 106 is currently not watching any digital content file, and desires to access a digital content file (for example, the first digital content file) on the electronic device 106. The first digital content file may be accessible to the user at no cost. The system server 102 may process the first request and present the first digital content file on the graphical user interface of the electronic device 106.

The system server 102 may receive the request (for example, the second request) directly from the electronic device 106 when the user of the electronic device 106 is currently watching a digital content file (for example, the first digital content file), and desires to access a new digital content file (for example, the second digital content file) on the electronic device 106. In some instances, the system server 102 may receive the second request from the media streaming application executed on the electronic device 106 when the user of the electronic device 106 is currently watching the first digital content file, and desires to access the second digital content file on the electronic device 106 via the media streaming application. The second request may include a name of the second digital content file, which the user may want to purchase and access on the electronic device 106. The second request may further include the sensor data. The sensor data may include voice data and eye movement data of the user.

The system server 102 may initiate and execute an authentication process for verification of an identity of the user and payment information associated with a payment card of the user on receiving the second request. During the authentication process, the system server 102 may process the eye movement data associated with the user. The eye movement data may include eye gaze data of the user relative to the graphical user interface of the electronic device 106 while the user was watching the first media content file on the electronic device 106. The eye gaze data may include periods of prolonged fixations (for example, dwell times) while the eyes of the user was moving over different virtual interactive objects in the first digital content file. For example, the eye gaze data may include information associated with a first prolonged fixation when the user was viewing a first virtual interactive object in the first media content file and a second prolonged fixation when the user was viewing a second virtual interactive object in the first media content file. The system server 102 may select all such virtual interactive objects, which may be looked upon by the user in a predetermined sequence from the first digital content file based on the eye gaze data of the user.

The system server 102 may determine whether all these virtual interactive objects, which have been selected in the predetermined sequence from the first digital content file based on the eye gaze data of the user form a preselected password of the user stored in the database 112. When these virtual interactive objects selected in the predetermined sequence form the preselected password of the user, the system server 102 may authenticate the user as a given user of the preselected password and approve a transaction for purchase of the second media content file using the payment information of the user.

The system server 102 may forward transaction information associated with the transaction to a record server 104 over the network 124 to conduct the transaction. The transaction information may include a transaction claim to process the transaction by enabling transfer of money associated with the transaction from an account of the user to an account associated with the media streaming application. The record server 104 may receive and process the transaction claim. The record server 104 may communicate the transaction claim with a computer of a financial institution, e.g., a bank that issued the payment card of the user. The computer of the financial institution may receive and process the transaction claim by transferring money from the account of the user to the account associated with the media streaming application. To transfer money between the account of the user and the account associated with the media streaming application, the computer of the financial institution may receive the payment amount associated with the transaction by processing the payment card of the user and hold the payment amount. The computer of the financial institution may push the payment amount to the account associated with the media streaming application on receiving an instruction from the system server 102. The computer of the financial institution may transmit a notification to the system server 102 via the record server 104 when the payment associated with the transaction is transferred from the account of the user to the account associated with the media streaming application.

The system server 102 may generate an authentication notification when the payment associated with the transaction is transferred from the account of the user to the account associated with the media streaming application. The authentication notification may indicate that the user is authenticated and the payment associated with the transaction has been processed. The system server 102 may transmit the authentication notification to the electronic device 106. Upon receipt of the authentication notification, the graphical user interface of the electronic device 106 may display a note. The note may specify that the payment associated with the transaction has been successfully processed and the transaction is approved. The graphical user interface of the electronic device 106 may then automatically play the second digital content file.

When these virtual interactive objects, which have been selected by the user in the predetermined sequence does not form the preselected password of the user, the system server 102 may display a prompt on a personal mobile device of the user requesting an input of a personal identification number associated with the payment card. A user interface of the personal mobile device may display a personal identification number field to receive the personal identification number associated with the payment card. The user may use its eyes and/or voice to interact with a software application (for example, a virtual assistant application) or a hardware device (for example, a keypad) of the personal mobile device, and submit the personal identification number associated with the payment card in the personal identification number field. Upon the entry of the personal identification number in the user interface, the system server 102 may compare inputted personal identification number in the personal identification number field with a personal identification number stored in the user profile associated with the user. When the inputted personal identification number in the personal identification number field match the personal identification number within the user profile, the system server 102 may authenticate the user and confirm that the payment card used by the user for conducting the transaction belongs to the user. The system server 102 may then approve the transaction and present the second digital content file on the graphical user interface of the electronic device 106.

The system server 102 may receive and process the voice data associated with the user during the authentication process. The voice data may include a voice recording of the user while the user was watching the first media content file on the electronic device 106. The voice data may include a secret word or phrase. The voice data may further include names of different virtual interactive objects visible in the first digital content file at different times. The system server 102 may execute a voice to text algorithm using the voice recording of the user as an input. The system server 102 may convert the voice recording into a text file. The system server 102 may parse the text file to select all virtual interactive objects from the first digital content file mentioned by the user in a same order of sequence. The system server 102 may determine whether all these virtual interactive objects, which have been selected in the predetermined sequence from the first digital content file based on the voice data of the user form the preselected password of the user stored in the database 112. When these virtual interactive objects selected in the predetermined sequence form the preselected password of the user, the system server 102 may authenticate the user as the given user of the preselected password. The system server 102 may further approve the transaction and present the second digital content file on the graphical user interface of the electronic device 106.

A record server 104 may be a computer of a card payment network e.g., Visa or MasterCard, etc. The record server 104 may be hosted by a financial institute, which may provide a service to the financial institute. The record server 104 may maintain information regarding a balance of an account maintained by the user at the financial institute. Certain parties, such as the user who is an account owner or an administrator of the system 100, may assume certain risks that an account holder does not have sufficient funds to fund the transaction, until the record server 104 authorizes the transaction. Upon receiving the request for the transaction, the system server 102 may forward associated information to the record server 104, which maintains an account corresponding to the balance of the user. The financial institute may generate an authorization response to forward to the record server 104, back through other devices in a payment stream and eventually to the system server 102 to confirm that the user or recipient may complete the transaction. The system server 102 may either receive authorization from the financial institute or create a custom authorization in order to authorize the transaction requests.

A database 112 may be directly or indirectly associated with the one or more database servers 114, the one or more system servers 102, the one or more record servers 104, the electronic file generator 110, and the one or more electronic devices 106. The database 112 may be capable of storing data in a plain format and an encrypted version. The database 112 may receive the data in the plain format, which may be encrypted by the one or one or more database servers 114. The data may include information associated with the user profile and the digital content files. The database 112 may have a logical construct of data files, which may be stored in non-transitory machine-readable storage media, such as a hard disk or memory, controlled by software modules of a database program (e.g., SQL), and a database management system that executes the code modules (e.g., SQL scripts) for various data queries and management functions.

FIG. 2 shows an electronic device 200 used by a user. The electronic device 200 is a headset. The headset may be a virtual reality headset, which is a head-mounted device that may provide virtual reality for the user. Some alternate embodiments may include any type of the electronic device 200. For example, the electronic device 200 may be a mobile device or a display device in form of glasses, goggles, or any other structure that supports and incorporates various components of the electronic device 200, as well as serves as a conduit for electrical and other component connections.

The electronic device 200 may include processors, transmitters, receivers, communication components, antennas, user interfaces, sensors, cameras, and input devices. The processors of the electronic device 200 may perform one or more operations according to one or more programming instructions.

The electronic device 200 may be capable of communicating with a system server, an electronic file generator, and a database using wired or wireless communication capabilities. The server and the electronic file generator may be associated with a media streaming application running on the electronic device 200.

The electronic device 200 may include a display screen 202. The display screen 202 may include one or more of display components, such as a cathode ray tube, a liquid crystal display, an organic light-emitting diode display, an active matrix organic light emitting diodes display, a super-active matrix organic light emitting diodes display, a plasma display, an incandescent light, a fluorescent light, a front or a rear projection display, or a light emitting diode indicator. The display screen 202 may be connected to a processor of the electronic device 200 for entering data and commands in form of eye gaze gestures, voice commands, etc. The display screen 202 may further include an imaging system, which may be implemented with a number of micro display panels, lenses, and reflecting elements to display and project an image. The display panels, lenses, and reflecting elements of the imaging system may be implemented with various display technologies, such as implemented with a transparent liquid crystal display, or using a projection technology. The projection technology may be implemented using liquid crystal display type displays with powerful backlights and high optical energy densities. Alternatively, a micro display and/or reflecting element may be implemented using a reflective technology, such as digital light processing and liquid crystal on silicon that reflects external light, which is reflected and modulated by an optical material.

The electronic device 200 may include a software product, for example, the media streaming application executed by the processors of the electronic device 200. The media streaming application may be operable for Android, Oculus Rift, OpenVR, iOS, Steam VR, windows mixed reality, PlayStation VR, and any other supported controllers and systems. The media streaming application may be associated with an intelligent virtual assistant software agent, which may perform tasks or services for the user based on eye movements of the user. The electronic device 200 may also include the intelligent virtual assistant software agent.

The user may use the electronic device 200 to execute the media streaming application and watch a first movie. The display screen 202 may present the first movie. The user using the electronic device 200 may be able to look around an artificial world of the first movie, move around in the artificial world, and visually interact with multiple virtual interactive objects in an immersive environment of the first movie to pause the first movie, stop the first movie, select a second movie, and make a payment for the second movie. The user may visually interact with the multiple virtual interactive objects in the first movie through eye gaze and eye movements of the user relative to the display screen 202 presenting the first movie.

FIG. 3 shows an electronic device 300 used by a user. The electronic device 300 is a headset. The headset may be an augmented reality headset, which is a head-mounted device that may provide augmented reality for the user. The electronic device 300 may include processors, transmitters, receivers, communication components, antennas, user interfaces, sensors, cameras, and input devices. The electronic device 300 may be capable of communicating with a system server, an electronic file generator, and a database using wired or wireless communication capabilities. The server and the electronic file generator may be associated with a media streaming application running on the electronic device 300. The media streaming application may be associated with an intelligent virtual assistant software agent, which may perform tasks or services for the user based on voice commands of the user.

The electronic device 300 may include a display screen 302. The user may use the electronic device 300 to execute the media streaming application and watch a first movie. The display screen 302 may present the first movie. The first movie may present an interactive experience of a real-world environment where various virtual interactive objects that reside in the real world may be enhanced by computer-generated perceptual information. The user using the electronic device 300 may be able to interact with the virtual interactive objects in the first movie using vocal commands to pause the first movie, stop the first movie, select a second movie, and make a payment for the second movie.

FIG. 4 shows an electronic device 400 of a user. A first movie may be presented on a display screen 402 of the electronic device 400, which may be watched by the user. The first movie may be presented via a media streaming application on the display screen 402. While watching the first movie, the user may be able to visually or vocally interact with a portion of the display screen 402 to select a second movie for viewing after the first movie. Upon selecting the second movie, the user may have to make a payment to buy the second movie. For this purpose, the user may have to be authenticated so that a payment card of the user may be charged for making the payment to buy the second movie. The user may be able to be authenticated while watching the first movie. For instance, the first movie may include a scene having multiple virtual interactive objects, such as a first virtual object 404, a second virtual object 406, a third virtual object 408, and a fourth virtual object 410. While the scene is presented on the display screen 402, a server may be able to select the first virtual object 404, the second virtual object 406, the third virtual object 408, and the fourth virtual object 410 based on eye gaze position of the user. For example, when eye gaze time of the user while viewing the first virtual object 404, the second virtual object 406, the third virtual object 408, and the fourth virtual object 410 on the display screen 402 is over a certain time, all these virtual objects are selected. If these selected virtual objects form a predetermined graphical password of the user, the user is authenticated in a background process while watching the first movie. The payment card of the user is charged to make the payment for the second movie. The second movie may then be presented via the media streaming application on the display screen 402.

FIG. 5 shows an electronic device 500 of a user. A first movie may be presented on a display screen 502 of the electronic device 500, which may be watched by the user. The first movie may be presented via a media streaming application on the display screen 502. While watching the first movie, the user may be able to visually or vocally interact with a portion of the display screen 502 to select a second movie for viewing after the first movie. Upon selecting the second movie, the user may have to make a payment to buy the second movie. For this purpose, the user may have to be authenticated so that a payment card of the user may be charged for making the payment to buy the second movie. The user may be able to be authenticated while watching the first movie. For instance, the first movie may include a scene having multiple virtual interactive objects, such as a first virtual object 504, a second virtual object 506, a third virtual object 508, and a fourth virtual object 510. While the scene is presented on the display screen 502, a server may be able to select the first virtual object 504, the second virtual object 506, the third virtual object 508, and the fourth virtual object 510 based on voice commands and voice queries of the user. If these selected virtual objects form a graphical password of the user, the user is authenticated in a background process while watching the first movie. The payment card of the user is charged to make the payment for the second movie. The second movie may then be presented via the media streaming application on the display screen 502.

FIG. 6 shows execution steps of user authentication, according to a method 600. The method 600 shown in the FIG. 6 may include execution steps 602, 604, 606, 608, 610, and 612. However, it should be appreciated that other embodiments may comprise additional or alternative execution steps, or may omit one or more steps altogether. It should also be appreciated that other embodiments may perform certain execution steps in a different order; steps may also be performed simultaneously or near-simultaneously with one another. In addition, the method 600 of the FIG. 6 is described as being executed by a server computer in this embodiment. The server computer executing one or more steps may be programmed to execute various other, unrelated essential features. The steps may also be executed by a plurality of server computers operating in a distributed computing and network environment.

In a first step 602, a server may open an account of a user associated with a media streaming application based on inputs of the user received from an electronic device of the user. The inputs may include a username. The inputs may further include a preselected password associated with on online bank account of the user. The preselected password may include an arrangement of one or more virtual interactive objects, which may be present in any digital content file, such as a movie. The one or more virtual interactive objects may include items, images, characters, letters, humans, texts, symbols, pictures, etc. The arrangement of the one or more virtual interactive objects may correspond to an interactive storytelling (for example, escape, gambling, treasure hunts or games of chance) in the digital content file.

The server may accept the preselected password as a given password of the user during creation of the account based a strength of the preselected password. In one instance, the server may determine the strength of the preselected password based on a number of objects chosen in the preselected password. Accordingly, when the number of objects chosen in the preselected password exceeds a threshold, the server may approve and accept the preselected password as a given password of the user. In another instance, the server may determine the strength of the preselected password based on a number of categories of objects from which the user selects the predefined number of objects. Accordingly, when the number of categories of objects from which the user selects the preselected password exceeds a threshold, the server may approve and accept the preselected password as the given password of the user.

Upon opening the account when the user accesses the media streaming application on the electronic device, the user using the electronic device may generate and transmit a first request. The server may receive the first request. The first request may be associated with viewing a first digital content file on a graphical user interface of the electronic device. The server may retrieve the first digital content file from a digital content source associated with the media streaming application. The first digital content file may be a video data file, which may include a plurality of virtual interactive objects.

In a next step 604, the server may present the first digital content file on a graphical user interface of the electronic device. The user may play and watch the first digital content file on the graphical user interface of the electronic device. The first digital content file may be an augmented reality video viewed by the user using the electronic device. The first digital content file may be a virtual reality video viewed by the user using the electronic device.

In a next step 606, while the user is watching the first digital content file on the graphical user interface of the electronic device, the user may want to view another digital content file, such as a second digital content file on the electronic device immediately or after watching the first digital content file. The user may then visually (for example, using eye movements) or vocally (for example, using voice queries) interact with the media streaming application to generate a second request. The second request is associated with access to the second digital content file. The media streaming application may be associated with an intelligent virtual assistant software agent, which may perform tasks or services for the user based on voice commands or eye movement commands. For instance, while the user is watching media content of the first digital content file on the electronic device via the media streaming application, the server may select a first virtual interactive object being shown in the first digital content file based on the voice uttered by the user mentioning about the first virtual interactive object or the eye movement of the user relative to the first virtual interactive object presented on the graphical user interface. The first virtual interactive object may be associated with the second digital content file, and as a result, the selection of the first virtual interactive object may correspond to a demand by the user to view the second digital content file.

The electronic device may transmit the second request to the server. The server may receive the second request from the electronic device. The second request may include eye movement data or voice data associated with the user. The user may have to purchase the second digital content file before the electronic device is able to receive the second digital content file from the server.

In a next step 608, the server may initiate an authentication process for verification of an identity of the user and payment information associated with a payment card of the user to purchase the second digital content file. In one embodiment, during the authentication process, the server 102 may have the eye movement data or the voice data associated with the user. The server 102 may process the eye movement data or the voice data associated with the user. In another embodiment, during the authentication process, the server 102 may request the user to submit credentials on the graphical user interface using eye movement of the user or voice commands of the user. When the user may submit the credentials on the graphical user interface using the eye movement or the voice commands, a sensor associated with the electronic device may generate sensor data. The sensor data may include the eye movement data or the voice data associated with the user.

In a next step 610, the server may process the eye movement data or the voice data associated with the user. In one embodiment, the server may select a predefined number of virtual interactive objects in a predetermined sequence from the first digital content file being played on the electronic device based on tracking of an eye movement of the user relative to the graphical user interface when the first digital content file was presented on the graphical user interface using the eye movement data. For example, the server may select these predefined numbers of virtual interactive objects when the user may have constantly looked upon each of these predefined number of virtual interactive objects over a predetermined period of time while watching the first digital content file. In another embodiment, the server may select the predefined number of virtual interactive objects in the predetermined sequence from the first digital content file being played on the electronic device based on recognizing a voice uttered by the user using the voice data of the user. For instance, the server may select these predefined numbers of virtual interactive objects when the user may have uttered a name of each of these predefined number of virtual interactive objects while watching the first digital content file.

In a next step 612, the server may determine whether the predefined number virtual interactive objects selected in the predetermined sequence from the first digital content file form a preselected password of the user stored in the database. The server may authenticate the user as a given user of the preselected password when the predefined number of virtual interactive objects selected in the predetermined sequence form the preselected password of the user.

The server may approve a transaction for purchase of the second media content file using the payment information of the user upon authentication of the user. The server may forward transaction information associated with the transaction to a record server to conduct the transaction. The record server may receive and process the transaction information. The record server may communicate the transaction information with a computer of a financial institution, e.g., a bank that issued the payment card of the user. The computer of the financial institution may receive and process the transaction by transferring money from the account of the user to an account associated with the media streaming application. The computer of the financial institution may transmit a notification to the server via the record server when the payment associated with the transaction is transferred from the account of the user to the account associated with the media streaming application. When the server receives the notification, the server may present the second digital content file on the graphical user interface of the electronic device. The second digital content file may be an augmented reality video viewed by the user using the electronic device. The second digital content file may be a virtual reality video viewed by the user using the electronic device.

In one example, a user may use a mobile device to watch a first television show. The mobile device may be associated with a media streaming application, which may present the first television show to the user. While the user is watching the first television show, the media streaming application may detect, based on an eye movement of the user relative to a display screen of the mobile device that the user is requesting to watch a second television show. The user may be prompted to make a payment for the second television show while also allowing the user to continue watching the first television show. The user may be presented with a navigation menu on a portion of the display screen to enter a password and make the payment. The user may interact with the display screen using eye gaze to enter the password. If the password is correct, the user is authenticated. The first television show is stopped and the second television show is presented on the display screen.

In another example, a user may use a virtual reality headset to watch a first movie. The virtual reality headset may be associated with a media streaming application, which may present the first movie to the user. While the user is watching the first movie, the media streaming application may detect when an eye gaze of the user is fixating at one or more graphical objects shown in the first movie over a predetermined amount of time. In a background process, a server associated with the media streaming application may determine if any of these one or more graphical objects indicate a request by the user to buy and present a second movie. When it is determined that the user is requesting the second movie, the server may further determine if remaining of these one or more graphical objects form a graphical password of the user, which may indicate an approval for a transaction to buy the second movie. The user is authenticated as a background process while the user is still watching the first movie when the one or more graphical objects form the graphical password. The second movie is presented on the display screen after the first movie is over.

In yet another example, a user may use a smart television to watch a first movie. The smart television may be associated with a media streaming application, which may present the first movie to the user. While the user is watching the first movie, a first graphical object is shown in the first movie, which may indicate a request for a second movie. The user may interact with the smart television using voice commands to select the first graphical object. The user may continue watching the first movie. The user may select a second graphical object and a third graphical object in the first movie using voice commands when the second graphical object and the third graphical object are shown in the first movie. A combination of the second graphical object and the third graphical object may form a graphical password of the user, which may indicate an approval for a transaction to buy the second movie. If the graphical password is correct and belongs to the user, the user is authenticated in the background process while the user is still watching the first movie. The second movie is presented on the display screen after the first movie is over.

In yet another example, a user may use a smart phone to watch a first movie. The smart phone may be associated with a media streaming application, which may present the first movie to the user. While the user is watching the first movie, the user may use voice commands to say a secret word or phrase. The secret word or phrase may indicate a request for a second movie. After uttering the secret word or phrase, the user may continue watching the first movie. While watching the first movie, the user may select multiple graphical objects in the first movie as a treasure hunt exercise using voice commands when the multiple graphical objects are shown in the first movie. When all the graphical objects of the treasure hunt are selected correctly, the user may be authenticated, which may indicate an approval for a transaction to buy the second movie. The second movie is presented on the display screen after the first movie is over.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the methods and embodiments described herein. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc, laser disc, optical disc, digital versatile disc, floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present subject matter. Various modifications to these embodiments will be readily apparent to those skilled in the art, and the generic principles defined herein may be applied to other embodiments without departing from the spirit or scope of the subject matter. Thus, the present subject matter is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
displaying, by a server, a first digital content file on a graphical user interface of an electronic device, wherein the first digital content file comprises a plurality of virtual interactive objects;
receiving, by the server, a request from the electronic device while the first digital content file is being displayed on the graphical user interface for presenting a second digital content file on the graphical user interface;
initiating, by the server, an authentication process for authenticating information associated with a user prior to presenting the second digital content file on the graphical user interface;
selecting, by the server, a predefined number of virtual interactive objects in a predetermined sequence from the first digital content file being displayed on the graphical user interface based on recognizing a voice uttered by the user or tracking an eye movement of the user relative to the graphical user interface during the authentication process;
when the predefined number of virtual interactive objects selected in the predetermined sequence form a preselected password of the user, authenticating, by the server, the user; and
displaying, by the server, the second digital content file on the graphical user interface of the electronic device.

2. The method of claim 1, further comprising:
receiving, by the server, the request from the electronic device in response to selection of a first virtual interactive object from the first digital content file based on recognizing the voice uttered by the user or tracking the eye movement of the user relative to the graphical user interface.

3. The method of claim 1, further comprising:
receiving, by the server, the request from the electronic device via a media streaming application running on the electronic device.

4. The method of claim 1, wherein the request comprises payment information for a payment card of the user.

5. The method of claim 1, further comprising:
accepting, by the server, the preselected password as a given password of the user during creation of the preselected password based a strength of the preselected password.

6. The method of claim 5, further comprising:
determining, by the server, the strength of the preselected password based on a number of virtual interactive objects chosen in the predefined number of virtual interactive objects.

7. The method of claim 5, further comprising:
determining, by the server, the strength of the preselected password based on a number of categories of virtual interactive objects from which the user selects the predefined number of virtual interactive objects.

8. The method of claim 1, wherein the first digital content file is an augmented reality video viewed by the user using the electronic device.

9. The method of claim 1, wherein the first digital content file is a virtual reality video viewed by the user using the electronic device.

10. The method of claim 1, wherein a digital content source maintains an account of the user, and wherein one or more electronic devices of the user are associated with the account on which a plurality of digital content files are presented.

11. A system comprising:
a server configured to:
retrieve a first digital content file displaying a plurality of virtual interactive objects from a digital content source, in response to receiving a first request from an electronic device operated by a user;
present the first digital content file on a graphical user interface of the electronic device;
receive a second request from the electronic device while the first digital content file is being played on the electronic device for presenting a second digital content file;
in response to receiving the second request, initiate an authentication process for authenticating information associated with the user prior to presenting the second digital content file on the electronic device;
select a predefined number of virtual interactive objects in a predetermined sequence from the first digital content file being played on the electronic device based on recognizing a voice uttered by the user or tracking an eye movement of the user relative to the graphical user interface during the authentication process;
when the predefined number of virtual interactive objects selected in the predetermined sequence form a preselected password of the user, authenticate the user; and
present the second digital content file on the graphical user interface of the electronic device.

12. The system of claim 11, wherein the server is further configured to:
receive the second request from the electronic device in response to selection of a first virtual interactive object from the first digital content file based on recognizing the voice uttered by the user or tracking the eye movement of the user relative to the graphical user interface.

13. The system of claim 11, wherein the server is further configured to:
receive the first request from the electronic device via a media streaming application running on the electronic device.

14. The system of claim 11, wherein the second request comprises payment information for a payment card of the user.

15. The system of claim 11, wherein the server is further configured to:
accept the preselected password as a given password of the user during creation of the preselected password based a strength of the preselected password.

16. The system of claim 15, wherein the server is further configured to:
determine the strength of the preselected password based on a number of virtual interactive objects chosen in the predefined number of virtual interactive objects.

17. The system of claim 15, wherein the server is further configured to:
determine the strength of the preselected password based on a number of categories of virtual interactive objects from which the user selects the predefined number of virtual interactive objects.

18. The system of claim 11, wherein the first digital content file is an augmented reality video viewed by the user using the electronic device.

19. The system of claim 11, wherein the first digital content file is a virtual reality video viewed by the user using the electronic device.

20. The system of claim 11, wherein the digital content source maintains an account of the user, and wherein one or more electronic devices of the user are associated with the account on which a plurality of digital content files are presented.
